(19) United States
(12) Patent Application Publication
(10) Pub. No.: US 2004/0156759 A1
(43) Pub. Date: Aug. 12, 2004

(54) Exhaust emission control device and system having reduced flow restriction

(76) Inventor: Michael R. Foster, Columbiaville, MI (US)

Correspondence Address: Vincent A. Cichosz, Delphi Technologies, Inc., M/C 480-410-202, P.O. Box 5052, Troy, MI, 48007, US

(21) Appl. No.: 10/361,116

(22) Filed: Feb. 6, 2003

(51) Int. Cl. B01D 53/34

(52) U.S. Cl. 422/177; 422/180; 422/179; 29/890

(57) ABSTRACT

Disclosed herein is an emission control device and system including the emission control device. The emission control device comprises a housing having exhaust gas inlet and outlet portions. The exhaust gas inlet portion is received within a flared end of an exhaust gas inlet tube, and the exhaust gas outlet portion is received within a flared end of the exhaust gas outlet tube. Cross-sectional flow areas of the inlet and outlet tubes are less than cross-sectional flow areas of unflared portions of the exhaust gas inlet portion and the exhaust gas outlet portion.

### BACKGROUND OF THE INVENTION

Exhaust emission control devices are used in an exhaust gas system, or other similar type system, to reduce an amount of a material within exhaust gas passing through the system. Exhaust emission control devices may include, for example, catalytic converters, evaporative emissions devices, scrubbing devices (e.g., hydrocarbon, sulfur, and the like), particulate filters/traps, adsorbers/absorbers, non-thermal plasma reactors, and the like, as well as combinations comprising at least one of the foregoing devices.

An exhaust emission control device typically includes a ceramic or other catalytic substrate disposed within a housing. The substrate may include a plurality of channels for an exhaust gas to pass through, with one or more catalytic materials disposed within the passages. The exhaust emission control device is secured to the exhaust gas system through openings in the ends of the housing. These openings may be simple holes in the ends of the housing, or may be sleeves extending from the ends of the housing. Tubing forming part of the exhaust gas system is placed inside the holes or sleeves, and the exhaust emission control device is welded to the outer surface of the tubing.

Typically, there is no “stop” built into the inlet and outlet openings of the exhaust emission control device, and the tubing can be placed a greater or lesser distance within the opening. While this allows the exhaust system length to be adjusted to some degree, which can compensate for assembly tolerances, over insertion of the tubing into the converter can cause the tubing to damage the substrate, and/or obstruct gas flow to the catalyst substrate.

### SUMMARY OF THE INVENTION

Disclosed herein is an exhaust gas system for communicating exhaust gas between an exhaust gas source and an exhaust gas destination, the exhaust gas system comprising a first tube in fluid communication between the exhaust gas source and the exhaust gas destination. The first tube includes a first flared portion proximate an extreme end of the first tube. The exhaust gas system further includes an exhaust emission control device in fluid communication between the exhaust gas source and the exhaust gas destination. The exhaust emission control device includes a housing and a substrate disposed in the housing. The substrate reduces an amount of a material within exhaust gas. The housing includes an exhaust gas inlet portion and an exhaust gas outlet portion disposed thereon. One of the exhaust gas inlet portion and the exhaust gas outlet portion extends within the first flared portion.

In one embodiment, the exhaust gas system further includes a second tube in fluid communication between the exhaust gas source and the exhaust gas destination, the second tube including a second flared portion proximate an extreme end of the second tube. The other of the exhaust gas inlet portion and the exhaust gas outlet portion extends within the second flared portion.

In another embodiment, a cross-sectional flow area of the first tube is less than a cross-sectional flow area of the one of the exhaust gas inlet portion and the exhaust gas outlet portion, and a cross-sectional flow area of the second tube is less than a cross-sectional flow area of the other of the exhaust gas inlet portion and the exhaust gas outlet portion.

The above-described and other features will be appreciated and understood by those skilled in the art from the following detailed description, drawings, and appended claims.

### BRIEF DESCRIPTION OF THE DRAWINGS

Referring now to the figures wherein the like elements are numbered alike:

FIG. 1 is a schematic diagram of an exhaust gas system;

FIG. 2 is a cross-sectional view of an exhaust emission control device coupled to inlet and outlet tubes; and

FIG. 3 is a partial cross sectional view of a portion of the exhaust emission control device of FIG. 2.

### DESCRIPTION OF THE PREFERRED EMBODIMENT

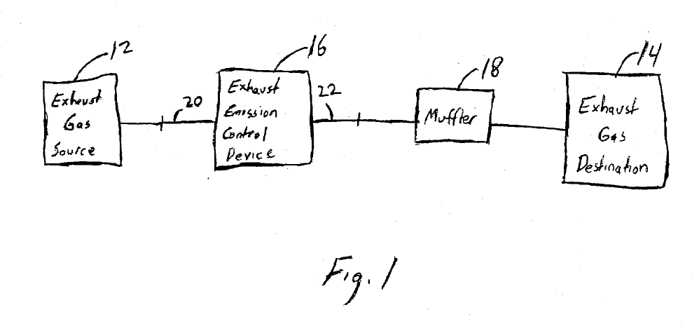

Referring to FIG. 1, an exhaust gas system 10 for communicating exhaust gas between an exhaust gas source 12 and an exhaust gas destination 14 is shown. Exhaust gas system 10 may be used, for example, in an automobile or other vehicle. Exhaust gas source 12 may be an internal combustion engine, including, for example, spark ignition engines, diesel engines, and the like. Exhaust gas destination 14 may be any desired destination for exhaust gas emitted from exhaust gas source 12. Such destinations may include, for example, an exhaust gas treatment device or system, atmosphere, or any other destination.

Exhaust gas system 10 includes an exhaust emission control device 16 in fluid communication between the exhaust gas source 12 and the exhaust gas destination 14. Exhaust emission control device 16 is a device used to reduce an amount of a material within exhaust gas passing through the system 10. Exhaust emission control device 16 may include, for example, catalytic converters, evaporative emissions devices, scrubbing devices (e.g., hydrocarbon, sulfur, and the like), particulate filters/traps, adsorbers/absorbers, non-thermal plasma reactors, and the like, as well as combinations comprising at least one of the foregoing devices. Exhaust gas system 10 may also include additional devices 18, such as one or more mufflers, additional exhaust emission control devices, and the like, in fluid communication between the internal combustion engine and the exhaust gas destination. Various lengths of tubing may extend between each of the devices in the exhaust gas system for communicating exhaust gas to each of the devices. Each length of tubing may be coupled to each device and to other lengths of tubing using any convenient means. Such means may include, for example, welding, flanges, press-fitting, brazing, and the like.

A length of tubing, hereinafter referred to as inlet tube 20, is coupled at one end to the exhaust emission control device 16 and is in fluid communication between the exhaust gas source 12 and the exhaust emission control device 16. The opposite end of inlet tube 20 may be coupled to another length of tubing within exhaust gas system, another component within exhaust gas system, or directly to exhaust gas source 12. Where inlet tube 20 is coupled directly to an internal combustion engine, inlet tube may be coupled to an exhaust manifold of the internal combustion engine or may be formed integral to the exhaust manifold of the internal combustion engine.

Another length of tubing, hereinafter referred to as outlet tube 22, is coupled at one end of the exhaust emission control device 16 and is in fluid communication between the exhaust emission control device 16 and exhaust gas destination 14. An opposite end of outlet tube 22 may be coupled to another length of tubing within exhaust gas system 10, another component within exhaust gas system 10, or may provide direct fluid communication between the exhaust emission control device 16 and the exhaust gas destination 14 (e.g., the outlet tube 22 may terminate to atmosphere).

In operation, exhaust gas exiting the exhaust gas source 12 is transferred to the exhaust emission control device 16 via inlet tube 20. Exhaust gas passes through the exhaust emission control device 16 towards exhaust gas destination 14 via outlet tube 22. In exhaust emission control device 16, an amount of a material within exhaust gas passing through the system 10 is reduced.

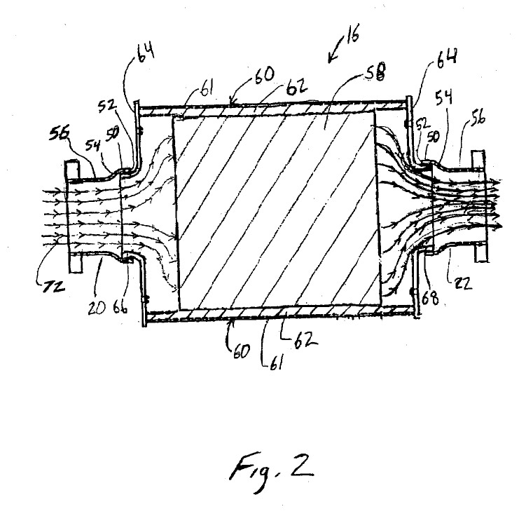

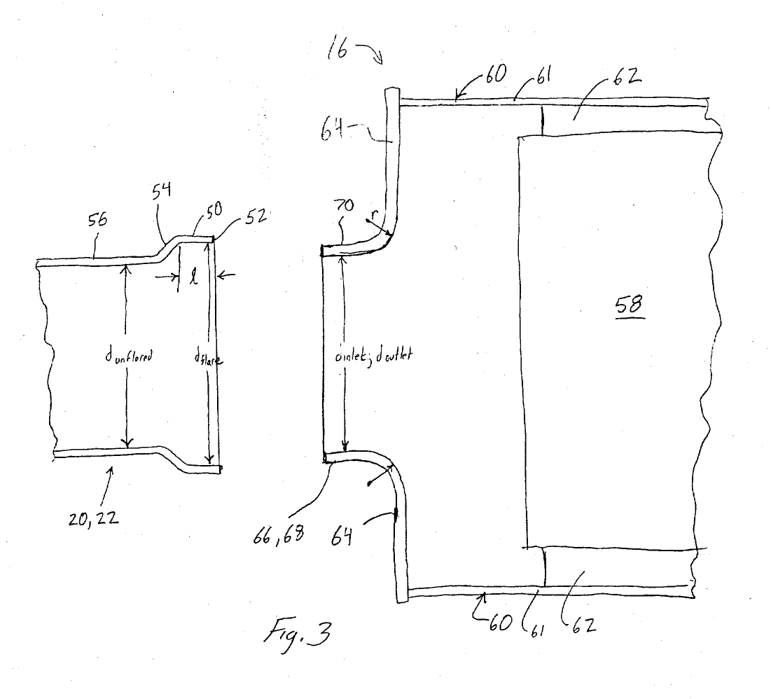

Referring to FIG. 2, a cross-sectional view of inlet tube 20, exhaust emission control device 16, and outlet tube 22 is shown. The inlet tube 20 and outlet tube 22 are hollow structures of any convenient cross sectional shape. In the embodiment described herein, inlet tube 20 and outlet tube 22 are generally cylindrical in shape. Inlet tube 20 includes a flared portion 50 proximate an extreme end 52 of the inlet tube 20. A shoulder 54 forms naturally due to material flow in the transition between the flared portion 50 and an unflared portion 56 of the inlet tube 20. As best can be seen in FIG. 3, flared portion 50 has a length “l” measured from the extreme end 52 of the inlet tube 20 to the shoulder 54. The inside diameter d_{flare} of the flared portion 50 may be constant throughout the length “l”.

Referring again to FIG. 2, outlet tube 22 includes a flared portion 50 proximate an extreme end 52 of the outlet tube 22. A shoulder 54 forms naturally due to material flow in the transition between the flared portion 50 and the unflared portion 56 of the outlet tube 22. Flared portion 50 has a length “l” measured from the extreme end 52 of the outlet tube 22. The inside diameter d_{flare} of the flared portion 50 may be constant throughout the length “l”.

Flared portions 50 may be formed on inlet and outlet tubes 20, 22 using any convenient method. For example, flared portions 50 may be formed by deforming (expanding) the inlet and outlet tubes 20, 22 to achieve the increased diameter d_{flare}. Alternatively, flared portions 50 may be formed separately from inlet and outlet portions 20, 22 and attached to inlet and outlet portions 20, 22 using any convenient means. Such means may include, for example, welding, press-fitting, brazing, and the like.

Exhaust emission control device 16 includes a ceramic or other catalytic substrate 58 disposed within a housing 60. The substrate 58 may include a plurality of channels for an exhaust gas to pass through, with one or more catalytic materials disposed within the channels. Such catalytic materials may include, for example, precious metals such as platinum, palladium, and rhodium, or any other catalytically active material selected for the final use of the exhaust emission control device 16. Located between the substrate 58 and the housing 60 may be a retention material 62 that also insulates the housing from both the high exhaust gas temperatures and the exothermic catalytic reaction occurring within the catalyst substrate 58, and prevents gases from bypassing the catalyst.

In the embodiment of FIG. 2, housing 60 includes a cylinder 61 formed from a rolled piece of sheet metal having ends 64 welded or otherwise attached to the open ends of the cylinder 61. Ends 64 of the housing are formed from flat plates, with the plate proximate inlet tube 20 including an exhaust gas inlet portion 66 disposed thereon, and with the plate proximate outlet tube 22 including an exhaust gas outlet portion 68 disposed thereon. Inlet portion 66 is a hollow structure protruding outward from one end 64 and generally having the same cross-sectional shape as the flared portion 50 of the inlet tube 20. In the embodiment shown, inlet portion 66 is a hollow cylinder having an outside diameter generally equal to or less than the inside diameter d_{flare} of the flared portion 50 of the inlet tube 20 such that inlet portion 66 may be inserted within the flared portion 50. The inlet portion 66 and inlet tube 20 are sized such that a cross-sectional flow area of the unflared portion 56 of the inlet tube 20 is less than a cross-sectional flow area of the inlet portion 66. In the embodiment shown, for example, the cross sectional flow area of the inlet portion 66 can be calculated as πdᵢₙₗₑₜ²/4, where dᵢₙₗₑₜ is the inside diameter of the inlet portion 66, and the cross sectional flow area of the inlet tube 20 can be calculated as πd_{unflared}²/4, where d_{unflared} is the inside diameter of the unflared portion 56 of the inlet tube 20. Connection between inlet portion 66 and end 64 is radiused, as indicated at “r”.

Outlet portion 68 is a hollow structure protruding outward from one end 64 and generally having the same cross-sectional shape as the flared portion 50 of the outlet tube 22. In the embodiment shown, outlet portion 68 is a hollow cylinder having an outside diameter generally equal to or less than the inside diameter d_{flare} of the flared portion 50 of the outlet tube 22 such that outlet portion 68 may be inserted within the flared portion 50. The outlet portion 68 and outlet tube 22 are sized such that a cross-sectional flow area of the unflared portion 56 of outlet tube 22 is less than a cross-sectional flow area of the outlet portion 68. In the embodiment shown, where outlet tube 22 and outlet portion 68 are of circular cross section, the cross-sectional flow area of the outlet portion 68 can be calculated as πdₒᵤₜₗₑₜ²/4, where dₒᵤₜₗₑₜ is the inside diameter of the outlet portion 68, and the cross-sectional flow area of the outlet tube 22 can be calculated as πd_{unflared}²/4, where d_{unflared} is the inside diameter of the outlet tube 22. Connection between outlet portion 68 and end 64 is radiused, as indicated at “r”. It will be appreciated that outlet portion 68 may be of a different shape and/or dimension than inlet portion 66 and that outlet tube 22 may be of different shape and/or dimension than inlet tube 20.

Exhaust gas inlet and outlet portions 66, 68 may be extruded from the plate forming the respective ends 64 of the housing 60, such that inlet portion 66 and one end 64 are formed from one piece of material, and outlet portion 68 and opposite end 64 are formed from another piece of material. Alternatively, housing 60 may include end cones welded to the open ends of the cylinder 61 to decrease the size (diameter) of each end of the housing 60 to facilitate connection to inlet and outlet tubes 20, 22. In another embodiment, the housing 60 may be die formed from sheet metal in two half shells which are then welded or otherwise attached at a common flange to form the housing 60. In this case, the common flanges on the two half shells terminates prior to the portion forming the inlet and outlet openings so the flared inlet and outlet can be assembled over the portion forming the inlet and outlet openings. In another embodiment, the ends 64 of the cylinder 61 are formed using a spinform method into conical shapes, thus eliminating the need for separate ends 64.

The choice of material for the housing 60 depends upon the type of gas to be treated, the maximum temperature reached by the substrate, the maximum temperature of the exhaust gas stream, and the like. Suitable materials for the housing 60 can comprise any material that is capable of resisting under-car salt, temperature, and corrosion. Typically, ferrous materials are employed such as ferritic stainless steels. Ferritic stainless steels can include stainless steels such as, e.g., the 400—Series such as SS-409, SS-439, and SS-441, with grade SS-409 generally preferred.

When the exhaust gas system 10 is assembled, the exhaust gas inlet portion 66 of the exhaust emission control device 16 is inserted into the flared portion 50 of the inlet tube 20, and the exhaust gas outlet portion 68 of the exhaust emission control device 16 is inserted into the flared portion 50 of the outlet tube 22. The length “l” of each of the flared portions 50 is selected such that the inlet and outlet portions 66, 68 abut the shoulder 54 formed on the inlet and outlet tubes 20, 22, respectively. The flared portion 50 of the inlet tube 20 and the flared portion 50 of the outlet tube 22 may then be welded to outer surfaces 70 of the exhaust gas inlet portion 66 and the exhaust gas outlet portion 68, respectively. The inside diameter d_{flare} of the flared portion 50 of the inlet tube 20 may be selected based on the outside diameter of the inlet portion 66 to maintain the inlet portion 66 in coaxial alignment with the inlet tube 20. Similarly, the inside diameter d_{flare} of the flared portion 50 of the outlet tube 22 may be selected based on the outside diameter of the outlet portion 68 to maintain the outlet portion 68 in coaxial alignment with the outlet tube 22.

It has been unexpectedly discovered that exhaust emission control device 10 reduces the restriction of exhaust gas flow from that possible with exhaust emission control devices of the prior art. By proving flared inlet and/or outlet tubing 20, 22 and having the inlet and/or outlet portions 66, 68 inserted therein, as described above, restriction to exhaust flow of an emission control device 10 is reduced by about 10 percent (%), compared to the amount of restriction of a similar device having non-flared inlet and outlet tubing disposed inside the inlet and outlet portions.

Samples were prepared and stand tested to determine resistance to a gas flowing at various air flow rates, given in grams per second (g/sec). The results are listed in Table 1, below, in terms of net inches of water back pressure generated by the device, as well as by % reduction in back pressure, based on the back pressure of the comparative examples having the prior art arrangement of the un-flared inlet and outlet tubing being disposed inside the inlet and outlet portions. The samples were tested at ambient pressure (about 29.6 Pbar), ambient temperature (about 16° C.) and ambient relative humidity (between about 42 and about 45%). In comparative example 1, a catalytic converter having end cones with non-flared inlet and outlet tubing disposed inside the inlet and outlet portions (the prior-art connection arrangement) was tested. In example 2, a catalytic converter fitted with end cones, with the connection between the outlet tube and the outlet portion arranged in accordance with an embodiment of the present invention, was tested. In example 3, a catalytic converter fitted with end cones, with the connection between the inlet tube and the inlet portion arranged in accordance with an embodiment of the present invention, was tested. In example 4, a catalytic converter fitted with end cones, with the connection between both the inlet tube and the inlet portion and the outlet tube and the outlet portion arranged in accordance with an embodiment of the present invention, was tested. In comparative example 5, a catalytic converter having end plates with non-flared inlet and outlet tubing disposed inside the inlet and outlet portions (the prior-art connection arrangement) was tested. In example 6, a catalytic converter fitted with end plates, with the connection between the outlet tube and the outlet portion arranged in accordance with an embodiment of the present invention, was tested. In example 7, a catalytic converter fitted with end plates, with the connection between the inlet tube and the inlet portion arranged in accordance with an embodiment of the present invention, was tested. In example 8, a catalytic converter fitted with end plates, with the connection between both the inlet tube and the inlet portion and the outlet tube and the outlet portion arranged in accordance with an embodiment of the present invention, was tested.

TABLE 1

| | | | | | % |
|---|---|---|---|---|---|
| | | | | | Reduction |
| | | | | | in Flow |
| | | | | | Restriction |
| | | | | Flow | based on |
| | Inlet | Outlet | Air Flow | Restriction | comparative |
| Example No | Configuration | Configuration | (g/sec) | (inches water) | example |
| Comparative | End Cone | End Cone | 150 | 20.45 | n/a |
| Example 1 | | | | | |
| Example 2 | End Cone | End Cone | 150 | 20.11 | 1.7% |
| | | with flared | | | |
| | | outlet tube | | | |
| Example 3 | End Cone | End Cone | 150 | 19.26 | 5.8% |
| | with flared | | | | |
| | inlet tube | | | | |
| Example 4 | End Cone | End Cone | 150 | 18.70 | 8.6% |
| | with flared | with flared | | | |
| | inlet tube | outlet tube | | | |
| Comparative | Flat Plate | Flat Plate | 150 | 22.88 | n/a |
| Example 5 | | | | | |
| Example 6 | Flat Plate | Flat Plate | 150 | 22.35 | 2.3% |
| | | with flared | | | |
| | | outlet tube | | | |
| Example 7 | Flat Plate | Flat Plate | 150 | 21.15 | 7.6% |
| | with flared | | | | |
| | inlet tube | | | | |
| Example 8 | Flat Plate | Flat Plate | 150 | 20.53 | 10.3% |
| | with flared | with flared | | | |
| | inlet tube | outlet tube | | | |

As the data of Table 1 shows, where the connection between the exhaust emission control device 16 and the inlet and/or outlet tube 20, 22 is arranged in accordance with an embodiment of the present invention the flow restriction was reduced from that of the comparative example. The greatest reduction is obtained when both the inlet and the outlet portions 66, 68 are disposed within flared inlet and outlet tubing 20, 22 (Examples 4 and 8).

In addition, the present invention may also provide a more uniform flow through the catalyst substrate 58 as compared to exhaust emission control devices having a non-flared inlet and outlet. Referring to FIG. 2, it is believed that flow restriction may be improved (i.e., reduced) by sizing dᵢₙₗₑₜ in an amount to cause the inlet flow plume of exhaust gas 72 to follow the radius “r” formed between inlet portion 66 and end 64. In doing so, a larger flow plume approximately equal to the inside diameter of the cylinder 61 may be formed. This action is believed to convert some of the velocity energy of the flow stream of exhaust gas 72 into a pressure energy, which would otherwise be lost. In addition, by providing a larger flow plume, the arrangement between the inlet tube 20 and inlet portion 66 described herein provides a more uniform velocity gradient within flow channels of the substrate 58. This more uniform velocity gradient is also believed to further reduce flow restriction, and to improve the efficiency of the emission control catalyst substrate 58.

In addition, use of the connection arrangement described herein prevents the inlet and/or outlet tube 20, 22 from projecting into the housing 60 past the ends 64. As such, the connection arrangement disclosed herein reduces and/or eliminates the issues associated with over-insertion of the inlet and outlet tubes 20, 22.

By using the same inlet and outlet tubing diameter now generally used to fit within the converter ends and forming it to include flared portions 50 to fit over the inlet and outlet portions 66, 68, material costs associated with the tubing 20, 22 do not increase over that of the prior art arrangement. Accordingly, use of a flared inlet and/or outlet tube 20, 22 provides the performance benefits described, with only a small additional cost associated with forming the flared tubes 20, 22.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An exhaust gas system for communicating exhaust gas between an exhaust gas source and an exhaust gas destination, the exhaust gas system comprising:
a first tube in fluid communication between the exhaust gas source and the exhaust gas destination, the first tube including a first flared portion proximate an extreme end of the first tube; and
an exhaust emission control device in fluid communication between the exhaust gas source and the exhaust gas destination, the exhaust emission control device including:
a housing having an exhaust gas inlet portion and an exhaust gas outlet portion disposed thereon, one of the exhaust gas inlet portion and the exhaust gas outlet portion extends within the first flared portion, and
a substrate disposed in the housing, the substrate for reducing an amount of a material within exhaust gas.

2. The exhaust gas system of claim 1, further comprising:
a second tube in fluid communication between the exhaust gas source and the exhaust gas destination, the second tube including a second flared portion proximate an extreme end of the second tube; and
wherein another of the exhaust gas inlet portion and the exhaust gas outlet portion extends within the second flared portion.

3. The exhaust gas system of claim 2, wherein a cross-sectional flow area of an unflared portion of the first tube is less than a cross-sectional flow area of the one of the exhaust gas inlet portion and the exhaust gas outlet portion, and wherein a cross-sectional flow area of an unflared portion of the second tube is less than a cross-sectional flow area of the other of the exhaust gas inlet portion and the exhaust gas outlet portion.

4. The exhaust gas system of claim 4, wherein the first tube, the second tube, the exhaust gas inlet portion, and the exhaust gas outlet portion have circular cross sections.

5. The exhaust gas system of claim 1, wherein a cross-sectional flow area of an unflared portion of the first tube is less than a cross-sectional flow area of the one of the exhaust gas inlet portion and the exhaust gas outlet portion.

6. The exhaust gas system of claim 5, wherein the first tube and the one of the exhaust gas inlet portion and the exhaust gas outlet portion have circular cross sections.

7. The exhaust gas system of claim 1, wherein the first flared portion is welded to an outer surface of the one of the exhaust gas inlet portion and the exhaust gas outlet portion.

8. The exhaust gas system of claim 1, wherein an end of the first tube opposite the flared portion includes a flange disposed thereon.

9. The exhaust gas system of claim 1, wherein the exhaust gas inlet portion and the exhaust gas outlet portion are extruded from a plate forming an end of the housing.

10. The exhaust gas system of claim 9, wherein a connection between the one of the exhaust gas inlet portion and the exhaust gas outlet portion and an end of the housing is radiused.

11. The exhaust gas system of claim 1, wherein the housing is formed in two half shells attached at a common flange.

12. The exhaust gas system of claim 1, wherein a shoulder is formed on the first tube proximate the flared portion, the shoulder being positioned at a first distance from the extreme end of the first tube, an extreme end of the one of the exhaust gas inlet portion and the exhaust gas outlet portion abutting the shoulder.

13. A method of assembling an exhaust gas system, the method including:
inserting an exhaust gas inlet portion of an exhaust emission control device into a flared portion of an inlet tube.

14. The method of claim 13, further comprising:
inserting an exhaust gas outlet portion of the exhaust emission control device into a flared portion of an outlet tube.

15. The method of claim 14, further comprising:
welding the flared portion of the inlet tube to an outer surface of the exhaust gas inlet portion; and
welding the flared portion of the outlet tube to an outer surface of the exhaust gas outlet portion.

16. The method of claim 14, further comprising:
abutting an extreme end of the exhaust gas inlet portion with a shoulder formed by the flared portion of the inlet tube; and
abutting an extreme end of the exhaust gas outlet portion with a shoulder formed by the flared portion of the outlet tube.

17. An exhaust emission control device comprising:
a housing having an exhaust gas inlet portion disposed thereon, the exhaust gas inlet portion being sized to extend within a first flared portion formed on an exhaust gas inlet tube; and
a substrate disposed in the housing, the substrate for reducing an amount of a material within exhaust gas.

18. The exhaust emission control device of claim 17, wherein the housing further includes an outlet portion disposed thereon, the exhaust gas outlet portion being sized to extend within a flared portion formed on an exhaust gas outlet tube.

19. The exhaust emission control device of claim 18, wherein a cross-sectional flow area of an unflared portion of the inlet tube is less than a cross-sectional flow area of the exhaust gas inlet portion.

20. The exhaust emission control device of claim 19, wherein the inlet tube and the exhaust gas inlet portion have circular cross-sections.

21. The exhaust emission control device of claim 19, wherein the first flared portion is welded to an outer surface of the exhaust gas inlet portion, and the second flared portion is welded to an outer surface of the exhaust gas outlet portion.

22. The exhaust emission control device of claim 18, wherein the exhaust gas inlet portion and the exhaust gas outlet portion are extruded from plates forming ends of the housing.

23. The exhaust emission control device of claim 17, wherein the housing is formed in two half shells attached at a common flange.

24. The exhaust emission control device of claim 17, wherein a connection between the exhaust gas inlet portion and an end of the housing is radiused.

25. The exhaust emission control device of claim 19, wherein a shoulder is formed on the inlet tube proximate the flared portion, the shoulder being positioned at a first distance from the extreme end of the inlet tube, an extreme end of the exhaust gas inlet portion abutting the shoulder.
